(19) United States
(12) Patent Application Publication
(10) Pub. No.: US 2011/0080068 A1
(43) Pub. Date: Apr. 7, 2011

(54) LAMINATED GENERATOR ROTOR STRUCTURE AND RELATED METHOD

(75) Inventors: Richard Nils Dawson, Voorheesville, NY (US); James Michael Fogarty, Schenectady, NY (US); Blake Weldon Wilson, Scotia, NY (US)

(73) Assignee: GENERAL ELECTRIC COMPANY, Schenectady, NY (US)

(21) Appl. No.: 12/574,448

(22) Filed: Oct. 6, 2009

(51) Int. Cl. H02K 1/28; H02K 15/02

(52) U.S. Cl. 310/216.114; 29/598

(57) ABSTRACT

A laminated generator rotor structure and a related method for repairing a rotor using a laminated rotor structure are disclosed. In an embodiment, the rotor body includes a stack of laminated plates flanked by end flange members, and placed in compression by at least one stud member passing through the laminated stack and secured by at least one fastener.

### BACKGROUND OF THE INVENTION

The subject matter disclosed herein relates generally to a rotor structure of an electric machine such as a generator. More particularly, the invention relates to an electric machine having a laminated rotor structure, and a related method for repairing a rotor using a laminated structure.

Conventional large, high speed generators typically include a stator and a rotor, the rotor rotating about a longitudinal axis within the stator to convert mechanical energy into electrical energy. The stator typically includes windings from which electrical power is output.

The rotor includes radially cut slots about the circumference of the rotor body, which extend lengthwise along the rotor body. These slots contain the coils which form the rotor field windings for carrying current. The rotor field windings are supported in place against centrifugal forces by using one of a number of different systems including, e.g., coil wedges which bear against the slot surfaces. The regions of the coils which extend beyond the ends of the rotor body are referred to as end windings, and are supported against centrifugal forces by retaining rings. The portion of the rotor shaft forging which is located under the rotor end windings is referred to as the spindle.

The rotor is typically formed from a solid single forging of high strength iron or steel, due to those materials' ability to provide the rotor with the required bending stiffness to support the rotor both statically and dynamically, and to transmit torque from the rotor to a drive flange of the generator for successful operation of a large, high speed generator. These solid single-forging rotors are expensive to produce, and limited production capacity yields very long lead times for ordering and manufacture.

Laminated rotor bodies have been used in small electric machines such as generators and motors to alleviate the expense and lead time associated with solid steel rotors. These laminated rotor bodies comprise laminations placed on, or attached to, a single steel shaft, such that the shaft provides the required bending stiffness for the rotor. Because the laminations do not carry a significant portion of the shaft bending load, the size of the generator or motor in which this type of rotor body can be used is limited.

Laminated rotor bodies have also been used in electric machines in which the stack of laminations is held in compression by a series of rods that pass through holes in the periphery of the laminations. Although the rod-compressed laminated stack carries a portion of the rotor bending load, the rods can only provide limited compression of the laminated stack, thus rendering a rod-compressed stack rotor unsuitable for use in electric machines such as large, high speed generators.

### BRIEF DESCRIPTION OF THE INVENTION

A laminated rotor structure for use in an electric machine such as a generator, and a related method for repairing a rotor using laminations are disclosed.

In a first aspect, a rotor is provided, the rotor comprising: a rotor body including a lamination stack, the stack including a plurality of stacked laminations, each lamination having a first thickness, each lamination further having a plurality of radially extending slots arranged about a circumference of each of the plurality of laminations; a first end flange member located on a first end of the lamination stack; a second end flange member located on a second end of the lamination stack; at least one stud member passing longitudinally through at least one hole in the lamination stack, the first end flange member, and the second end flange member, a first fastener affixed to a first end of each of the at least one stud member; a second fastener affixed to a second end of each of the at least one stud member; the first fastener and the second fastener providing a compression to the laminated stack; and a plurality of coils forming a rotor field winding positioned within the plurality of slots.

In a second aspect, an electric machine is provided, the electric machine comprising: a rotor including: a rotor body including a lamination stack, the stack including a plurality of stacked laminations, each lamination having a first thickness, each lamination further having a plurality of radially extending slots arranged about a circumference of each of the plurality of laminations; a first end flange member located on a first end of the lamination stack, a second end flange member located on a second end of the lamination stack, at least one stud member passing longitudinally through at least one hole in the lamination stack, the first end flange member, and the second end flange member, a first fastener affixed to a first end of each of the at least one stud member, at least a second fastener affixed to a second end of each of the at least one stud member, the first and second fasteners providing a compression to the laminated stack, a plurality of coils forming a generator rotor field winding positioned within the plurality of slots; and a stator surrounding the rotor.

In a third aspect, a method is provided, comprising: removing a first end portion of a rotor body; affixing at least one stud member to a first end of the rotor body; providing a plurality of laminations, each lamination having at least one hole in the lamination; stacking the laminations on a first end of the rotor body, including passing the at least one stud member through the at least one hole in the plurality of laminations, the stacking further including forming a laminated stack having a length equal to a length of the first portion of the rotor; placing an end flange member adjacent to the laminated stack, including passing the at least one stud member through the at least one hole in the end flange member; placing a spacer member adjacent to the end flange member, including passing the at least one stud member through the at least one hole in the spacer member; fastening the laminations, the end flange member, and the spacer member onto the at least one stud member with at least one fastener; compressing the laminated stack, including tightening the at least one fastener.

### BRIEF DESCRIPTION OF THE DRAWINGS

FIG. 1 depicts a three-dimensional view of a portion of a generator rotor according to embodiments of the invention.

FIG. 2 depicts a partial cutaway view of an asynchronous generator rotor with three phase rotor winding.

FIG. 3 depicts a cross-sectional view of a generator having a rotor and a stator according to embodiments of the invention.

FIG. 4 depicts a perspective view of a generator rotor including rotor field windings according to embodiments of the invention.

FIG. 5 depicts a cross-sectional view of a generator rotor according to embodiments of the invention.

FIG. 6 depicts perspective views of various parts of the generator rotor according to embodiments of the invention.

FIG. 7 depicts a front view of a rotor body lamination according to one embodiment of the invention.

FIG. 8 depicts a front view of a rotor body lamination according to another embodiment of the invention.

FIG. 9 depicts a detail view of a slot in a rotor body lamination according to embodiments of the invention.

FIG. 10 depicts a cross-sectional view of a generator rotor according to embodiments of the invention.

FIG. 11 depicts a three dimensional view of a rotor body lamination according to an embodiment of the invention.

FIG. 12 depicts a cross-sectional view of a forged generator rotor that has sustained damage to the rotor body.

FIG. 13 depicts a cross-sectional view of a generator rotor according to embodiments of the invention.

FIG. 14 depicts a cross-sectional view of a generator rotor according to an embodiment of the invention.

FIG. 15 depicts a front view of a rotor body lamination according to an embodiment of the invention.

### DETAILED DESCRIPTION OF THE INVENTION

At least one embodiment of the present invention is described below in reference to its application in connection with the operation of an electric machine. Although embodiments of the invention are illustrated relative to an electric machine in the form of a two-pole synchronous generator, it is understood that the teachings are equally applicable to other electric machines including, but not limited to, other types of generators such as generators having four or more poles and asynchronous generators with a three-phase rotor winding, or doubly-fed induction generators; and motors. Further, at least one embodiment of the present invention is described below in reference to a nominal size and including a set of nominal dimensions. However, it should be apparent to those skilled in the art that the present invention is likewise applicable to any suitable generator and/or engine. Further, it should be apparent to those skilled in the art that the present invention is likewise applicable to various scales of the nominal size and/or nominal dimensions.

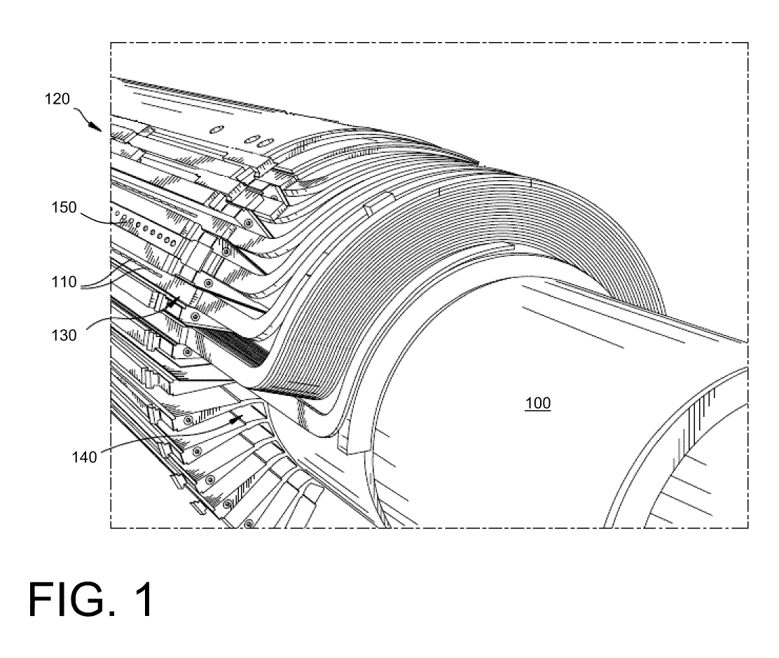

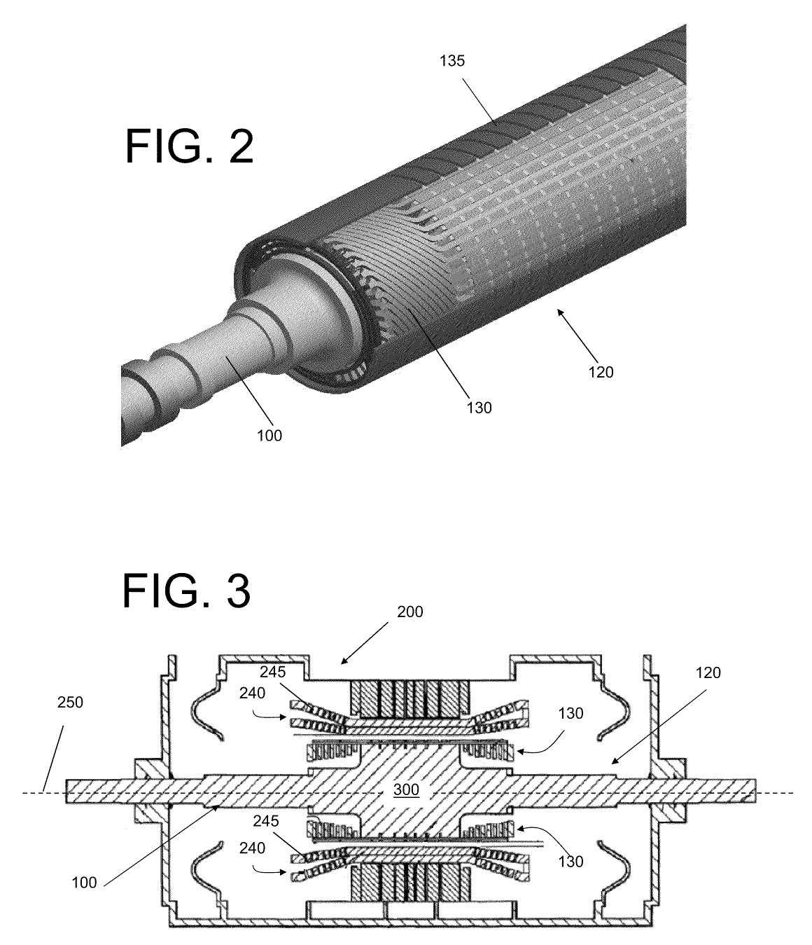

As indicated above, aspects of the invention provide a laminated rotor body structure and method of making the same. FIGS. 1-15 show different aspects of a generator, and specifically, configurations providing for a laminated rotor 120. FIG. 1 shows a three-dimensional perspective view of a portion of rotor 120, in an embodiment which may be included in an electric machine such as a two pole synchronous generator. Rotor 120 may include a spindle 100 and groups of coils 130 disposed about spindle 100. Each group of coils 130 may be contained within a plurality of slots 140. Further, each group of coils 130 may contain a plurality of ducts 110 to assist in cooling coils 130. FIG. 2 depicts a partial cutaway view of another embodiment in which rotor 120 includes coils 130, which may be arranged to form a three phase rotor winding, as in an asynchronous generator. Further aspects of the generator and rotor 120, as well as a method of repairing rotor 120, will be described with reference to FIGS. 3-13.

FIG. 3 shows a cross-sectional schematic view of a generator 200, including stator 240, and rotor 120 positioned within stator 240. Stator 240 includes groups of coils 245, and may comprise any now known or later developed stator structure. As shown, rotor 120 may have spindle 100 and groups of coils 130 disposed about spindle 100. Spindle 100 may be formed of, for example, iron or steel. Rotor 120 rotates about a longitudinal axis 250 within stator 240. Rotor 120 further includes rotor body 300, which comprises a multi-pole magnetic core. In rotor 120 depicted in FIG. 3, the magnetic core includes two poles.

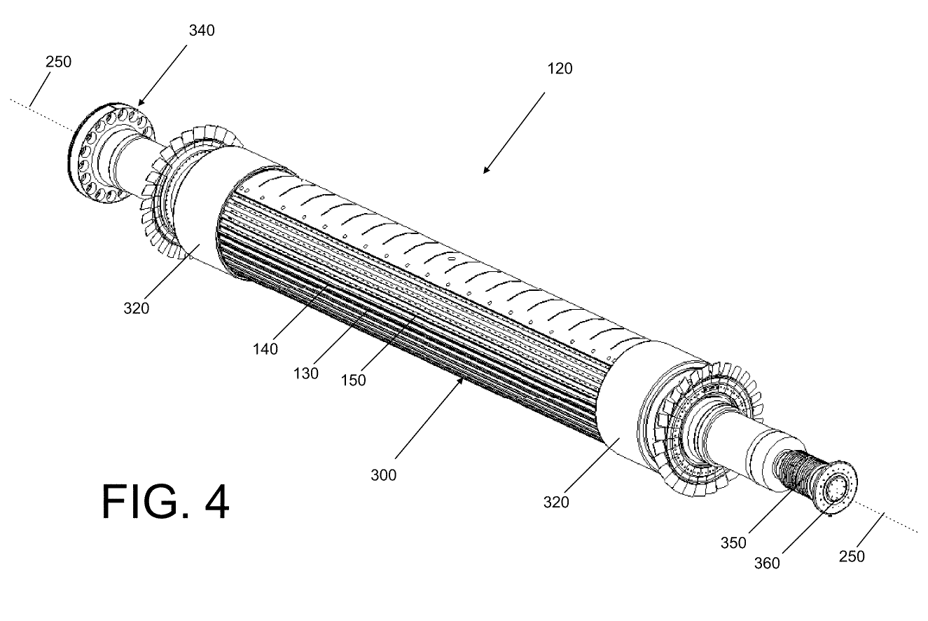

Rotor body 300 further includes a plurality of slots 140 which contain coils 130, forming the rotor field winding. As shown in FIGS. 1 and 4, in an embodiment, coils 130 may be held in place within slots 140 by coil wedges 150. Coils 130 are further held in place by retaining rings 320 on each end of rotor body 300, as depicted in FIG. 4. In other embodiments, coils 130 may be held in place by carbon fiber rings 135 (FIG. 2) or fiberglass banding (not shown), in which the uncured fiberglass banding material is wound under tension directly over rotor 120 and coils 130, and then cured.

Referring back to FIG. 4, drive coupling 340 is disposed between generator 200 and a source of mechanical energy, which may include a turbine or engine, and is configured to rotate rotor 120 with respect to stator 240. Rotation of rotor 120 results in an electrical current being created in groups of coils 245 affixed to stator 240 (FIG. 3), generating electricity. The current is then transmitted away from generator 200 for use in a variety of applications including, for example, powering homes and/or buildings.

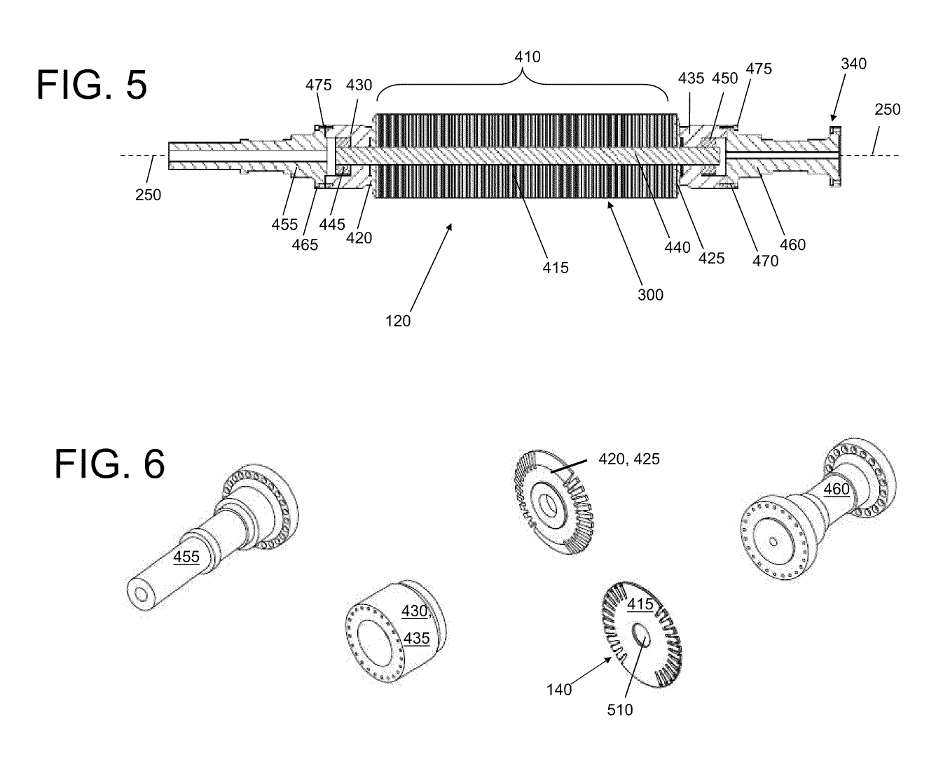

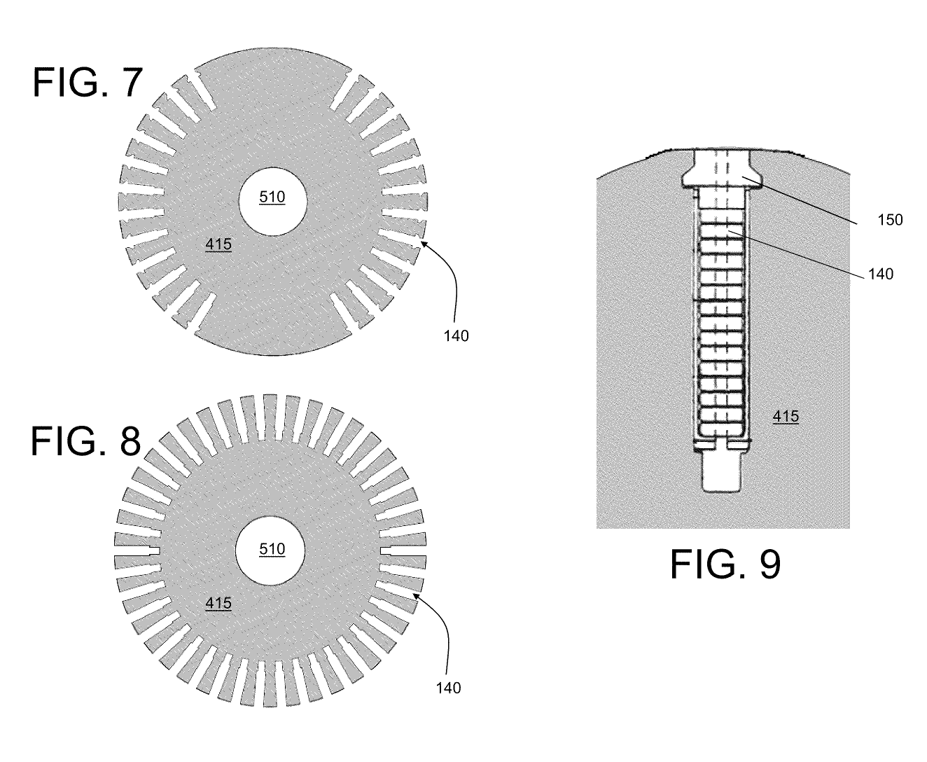

FIG. 5 shows rotor 120 according to an embodiment of the present invention, in which rotor body 300 comprises a stack 410 of a plurality of laminated plates, or laminations 415. As shown in FIGS. 6-9, each lamination 415 includes a plurality of radially extending slots 140 circumferentially arranged about at least a portion of the circumference of each lamination 415. FIG. 7 depicts an embodiment of a slot arrangement suited to a two pole synchronous generator. FIG. 8 depicts an embodiment of a slot arrangement suited to an asynchronous generator rotor having a three phase winding. As shown in FIGS. 6-8, each lamination 415 further includes a hole 510 passing through the lamination.

In various embodiments, the number of holes 510 may be one or greater than one. In further embodiments, laminations 415 are made of steel, and may be cut using any known method, including but not limited to machining, cutting with a laser, cutting with a water jet, or punching with a die. In still further embodiments, the laminations may undergo further processing to coat the surface of each lamination with an insulating layer or coating to provide electrical isolation between adjacent laminations 415, such as a phosphate based inorganic coating in accordance with ASTM C-5 electrical steel insulation. The insulating layer may measure between about 0.0015 mm and about 0.0035 mm in thickness. FIGS. 7-9 show an embodiment in which rotor coils 130 are held in place within slots 140 by coil wedges 150, however other embodiments may include, e.g., carbon fiber rings or fiberglass banding to hold coils 130 in slots 140.

The thickness of each lamination 415 varies with the size of generator 200. In one embodiment, each lamination 415 has a first thickness measuring between about 2 mm (about 0.07 inch) and about 25 mm (about 1.0 inch) in thickness, or more specifically, between about 6 mm (about 0.25 inch) and about 10 mm (about 0.375 inch) in thickness, and all subranges there between. These ranges of first thicknesses of lamination 415 are only illustrative, however, and are not intended to exclude the use of laminations that are either thinner or thicker than the aforementioned ranges, as the necessary and/or optimal thickness of the laminations 415 varies with the size and speed of the electric machine in which they are used and the manufacturing method used to cut the laminations.

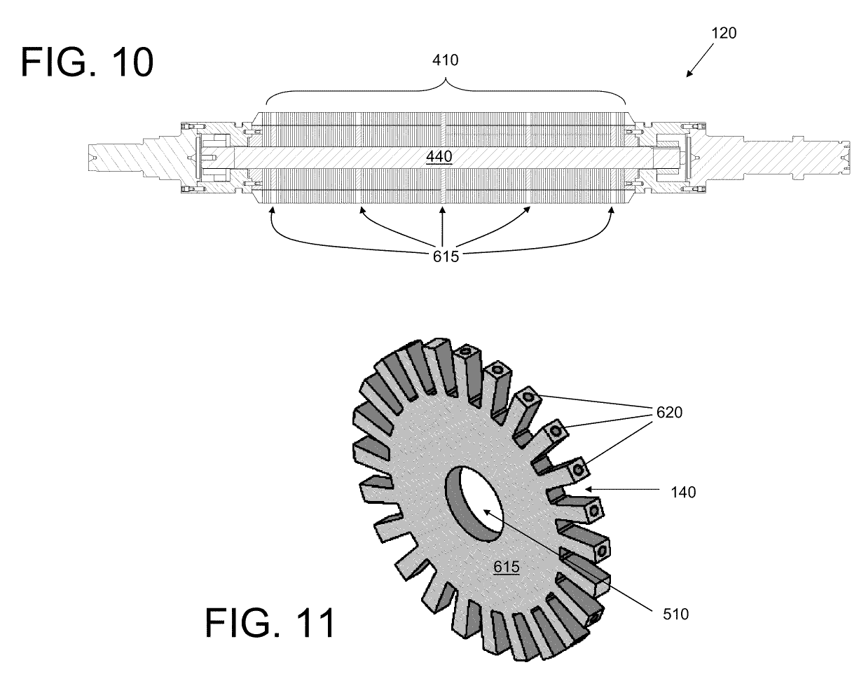

Referring back to FIG. 5, lamination stack 410 is flanked by a first end flange member 420 located on a first end of lamination stack 410, and by a second end flange member 425 located on a second end of lamination stack 410. First and second end flange members 420 and 425 may be, but need not be, part of the magnetically active portion of rotor 120 comprising rotor body 300. As shown in FIG. 10, lamination stack 410 may further include a plurality of thicker balancing laminations 615 for balancing the rotor. As shown in FIG. 10, balancing laminations 615 have a second thickness that is greater than the first thickness of the stacked laminations 415. Balancing laminations 615 may further include tapped holes 620 (FIG. 11) located around an outer circumference of the laminations 615, between the slots 140. The number and thickness of balancing laminations 615 and the number of holes 620 in the balancing laminations 615 are selected to provide adequate balance capability over the entire speed range over which the rotor will be used in service. In various embodiments, between about four and about eight balancing laminations 615 measuring between about 25 mm and about 40 mm thick, with approximately twenty 20-30 mm diameter tapped holes 620 may be used.

Referring back to FIG. 5, in an embodiment, lamination stack 410 and first and second end flange members 420 and 425 may further be flanked by a first spacer member 430 located adjacent to the first end flange member 420, and a second spacer member 435 located adjacent to the second end flange member 425. As shown in FIG. 6, end flange members 420, 425 and spacer members 430, 435 each further include a hole passing therethrough. In another embodiment, end flange members 420, 425 may include spacer members 430, 435, respectively, as constituent parts of the structure of the end flange members 420, 425. In such an embodiment, a separate spacer members 430, 435 may not be used. In yet another embodiment, spacer members 430, 435 and end flange members 420, 425 may each comprise a plurality of sub-components which together form the spacer member or end flange member structures as shown in FIG. 6.

Referring back to FIG. 5, stud member 440 passes through hole 510 in each of the stacked laminations 415 that comprises lamination stack 410, as well as through the holes in each of the first and second end flange members 420 and 425, and first and second spacer members 430 and 435 (if present). Stud member 440 comprises a high strength material which is able to maintain very high compression such as, for example, steel. In a further embodiment, stud member 440 may be threaded only on each of the ends of stud member 440.

First fastener 445 and second fastener 450 secure each of the ends of stud member 440, and, together with stud member 440, provide compression to laminated stack 410. Fasteners 445 and 450, which may include nuts, torque nuts or torque bolts including Superbolt® tensioners, or other threaded fasteners, may be tightened using any known means, including but not limited to: use of hydraulic tensioning equipment, heat tightening, and so on.

As shown in FIG. 6, in one embodiment, first end flange member 420 and second end flange member 425 are shaped to provide nearly uniform pressure over an entirety of a cross section of the lamination stack 410, the first and second end flange members 420, 425 being tapered in thickness such that the outer diameter of each flange 420, 425 initially contacts the outer diameter of lamination stack 410. As the compression load increases upon tightening of fasteners 445, 450, each end flange member 420, 425 deforms so the entire face of flange 420, 425 is in contact with the entire face of the ends of the lamination stack 410.

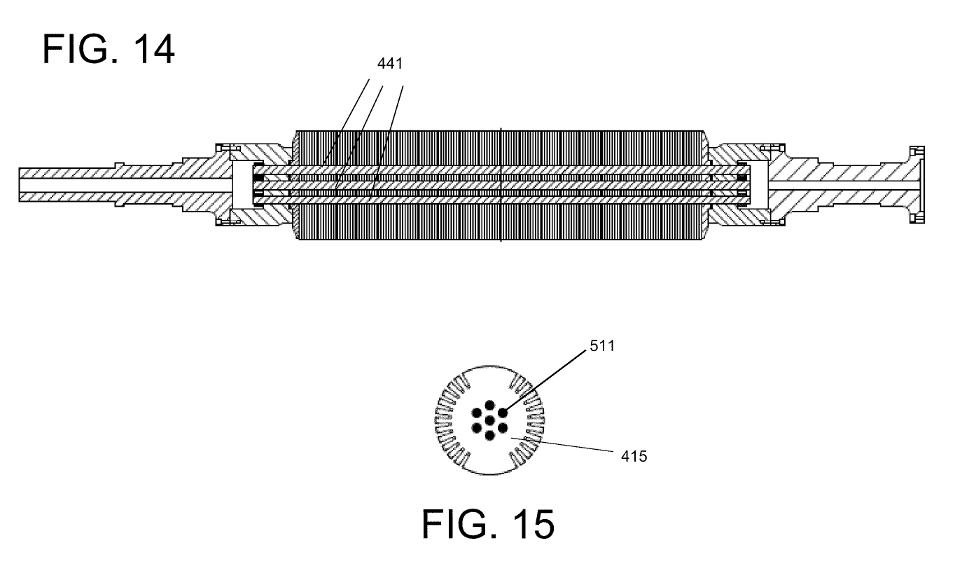

In an additional embodiment, laminations 415 and 615 may include more than one hole 511, through which more than one stud member 441 may pass, as shown in FIGS. 14-15. Although FIG. 15 depicts a lamination having seven holes, the number of stud members and holes may be any number between 1 and about 12. Where the number of stud members 441 is greater than one, each of the stud members 441 is secured by one of a plurality of fasteners 445, 450. Further, end flange members 420, 425; spacer members 430, 435; and laminations 415, 615 include at least as many holes as the rotor includes stud members.

Tightening of fasteners 445, 450 results in compression of laminated stack 410 at a pressure sufficient to provide the necessary bending stiffness to rotor body 300 and sufficient frictional capability to transmit a torque load from rotor body 300 to a drive shaft. The pressure necessary to accomplish this varies with the size of generator 200, and consequently, with the size of rotor 120. Larger machines require increased rotor stiffness, approaching that of a solid steel rotor. In one embodiment, stud member 440 and fasteners 445, 450 compress laminated stack 410 at a pressure of between about 7,000 kPa (about 1,000 psi) and about 50,000 kPa (about 7,250 psi), although this is merely illustrative. The pressures achieved are highly dependent on a variety of variables including but not limited to: the size of the rotor, the materials from which it is made, the extent to which fasteners 445, 450 are tightened, and so on.

As shown in FIG. 5, a non-drive end shaft spindle 455 may be affixed to first spacer member 430, and a drive end shaft spindle 460 may be affixed to the second spacer member 435. In various embodiments, spacer members 430, 435 each include a flange 465, 470 to which spindles 455, 460 may be affixed, respectively. In a further embodiment, spindles 455, 460 may be affixed to spacer members 430, 435 by a plurality of bolts 475, although any known method of adhesion such as welding may also be used. In further embodiments, drive end spindle 460 includes drive coupling 340, and is configured to operably connect rotor 120 to a source of mechanical energy such as, for example, a turbine, causing rotor 120 to rotate. In certain embodiments, it may be desirable to have two sources of mechanical energy connected to rotor 120, one connected to each end of the rotor. In this case spindle 455 may also be configured to have an auxiliary drive coupling 360 (FIG. 4) operably connected to rotor 120. Non-drive end spindle 455 is configured to operably connect coils 130 with coil collector rings 350, which are disposed about spindle 455 (FIG. 4), or a brushless exciter (not shown) to provide excitation current to the rotor coils 130.

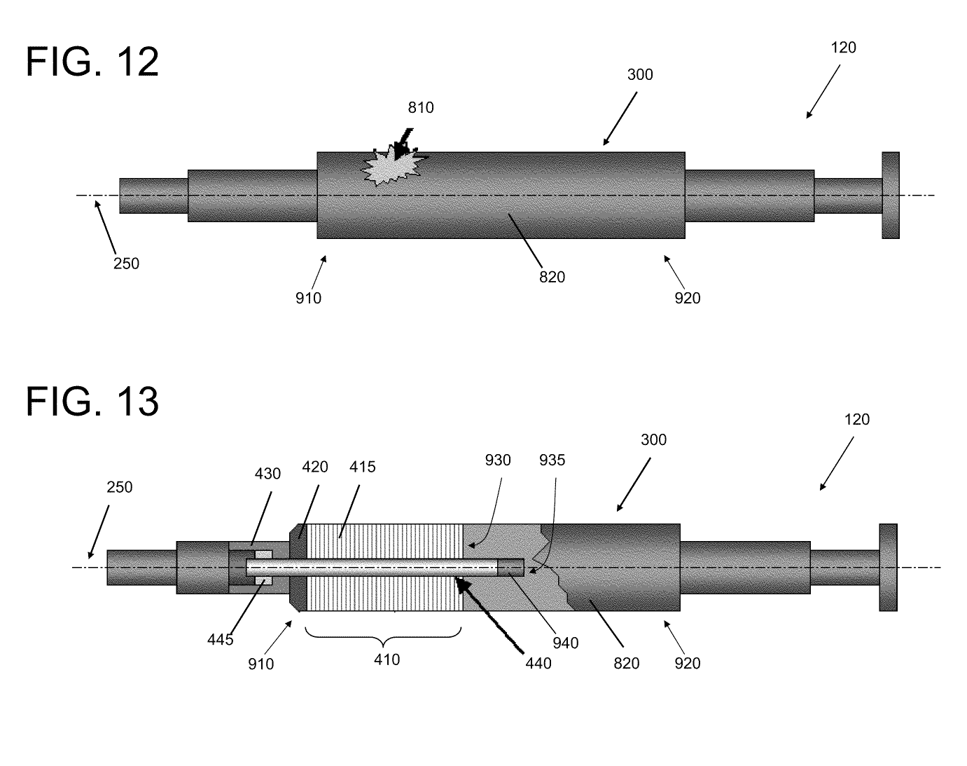

In another embodiment, a method is provided for replacing or repairing rotor 120 which has sustained damage 810, as shown in FIG. 12. Damage 810 to rotor body 300 may typically have occurred, e.g., while in service, in the course of long term cyclic duty, or under any other circumstances. Damage 810 may further have occurred on a rotor made from a solid forging 820. For clarity of description, the end of rotor body 300 which includes damage 810 will be referred to as first end portion 910, and the undamaged end of rotor body 300 will be referred to as second end portion 920. It is noted, however, that this nomenclature is only for clarity of description, and not to be construed as limiting in any way.

As shown in FIGS. 12-13, first end portion 910 of rotor body 300, including damage 810, is removed from rotor body 300, leaving a second end portion 920 of solid forging 820 remaining. Stud member 440, which may be made of steel in one embodiment, is affixed to a first end 930 of rotor body 300. In an embodiment, the affixing may include tapping a threaded hole 935 in the first end 930 of rotor body 300, threading a first end 940 of stud member 440, and threadably fastening first end 940 of stud member 440 into hole 935. In other embodiments, however, any other means of affixing known in the art may be used including, for example, welding stud member 440 to first end 930.

A plurality of laminations 415 is provided, each lamination 415 having a hole 510 therethrough. The laminations 415 are stacked on a first end 930 of rotor body 300, with stud member 440 passing through hole 510 in each of the plurality of laminations 415. Laminations 415, which may include steel in an embodiment, are stacked in sufficient number to form a laminated stack 410 having a length equal to the length of the removed first end portion 910 of rotor body 300. Lamination stack 410 may further include a plurality of thicker balancing laminations 615 (FIG. 10) for balancing the rotor as needed.

The thickness of each lamination 415 varies with the size of rotor 120. In one embodiment, each lamination 415 may measure between about 2 mm (0.072 inch) and about 25 mm (1.0 inch) in thickness, or more specifically, between about 6 mm (0.25 inch) and about 10 mm (0.375 inch) in thickness, and all subranges there between. Balancing laminations 615 have a second thickness that is greater than the first thickness of the stacked laminations 415. As described above, balancing laminations 615 may further include tapped holes 620 located around an outer circumference of the laminations 615, between the slots 140.

In one embodiment, late point identification may be employed, wherein the provided laminations 415 may be stocked, and later cut and stacked to the specific dimensional requirements of any generator design recited in the received specification.

As shown in FIG. 13, end flange member 420 is placed adjacent to the laminated stack 410. End flange member 420 further includes a hole through the center of flange member, through which stud member 440 passes. Spacer 430 may be placed adjacent to end flange member 420, with stud member 440 passing through spacer member 430. In another embodiment, end flange member 420 may include spacer member 430 as a constituent part of the structure of the end flange member 420. In such an embodiment, a separate spacer member 430 may not be used. In yet another embodiment, spacer member 430 and end flange member 420 may each comprise a plurality of sub-components which together form the spacer member or end flange member structures as shown in FIG. 6.

Stud member 440 passes through hole 510 in each of the stacked laminations 415 that comprises lamination stack 410, as well as through the holes in each of end flange member 420 and spacer member 430. In an embodiment, stud member 440 may be threaded only on each of the ends of stud member 440.

Laminations 415, end flange member 420, and spacer member 430 are fastened onto stud member 440 by a fastener 445. Fastener 445, together with stud member 440, provide compression to laminated stack 410. Fastener 445, which may include a nut, torque nut or torque bolt such as a Superbolt® tensioner, or any other threaded fastener, is tightened using any known means, including but not limited to using hydraulic tensioning equipment, heat tightening, and so on.

In an embodiment, end flange member 420 is shaped to provide nearly uniform pressure over an entirety of a cross section of the lamination stack 410, the end flange member 420 being tapered in thickness such that the outside diameter of end flange 420 initially contacts the outside diameter of the lamination stack 410. As the compression load increases, flange 420 deforms so the entire face of the flange 420 is in contact with the entire face of the end of the lamination stack 410.

In an additional embodiment, laminations 415 and 615 may include more than one hole 511, through which more than one stud member 441 may pass. The number of stud members and holes may be between 1 and 12. Where the number of stud members 441 is greater than one, each of the stud members 441 is secured by a fastener 445. Further, end flange member 420, spacer member 430, and laminations 415, 615 include at least as many holes as the rotor includes stud members

Laminated stack 410 is compressed at a pressure sufficient to provide the necessary bending stiffness to rotor body 300 and sufficient frictional capability to transmit a torque load from the resulting rotor body 300, which includes laminated first end portion 910 and forged second end portion 920, to a drive shaft. The pressure necessary to accomplish this varies with the size of rotor 120.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A rotor comprising:
a rotor body including a lamination stack, the stack including a plurality of stacked laminations, each lamination having a first thickness, each lamination further having a plurality of radially extending slots arranged about a circumference of each of the plurality of laminations;
a first end flange member located on a first end of the lamination stack;
a second end flange member located on a second end of the lamination stack;
at least one stud member passing longitudinally through at least one hole in the lamination stack, the first end flange member, and the second end flange member,
a first fastener affixed to a first end of each of the at least one stud member;
a second fastener affixed to a second end of each of the at least one stud member;
the first fastener and the second fastener providing a compression to the laminated stack; and
a plurality of coils positioned within the plurality of slots.

2. The rotor of claim 1, further including:
a first spacer member located adjacent to the first end flange member;
a second spacer member located adjacent to the second end flange member;
a non-drive end shaft spindle affixed to the first spacer member; and
a drive-end shaft spindle affixed to the second spacer member,
wherein the at least one stud member passes through at least one hole in each of the first and second spacer members.

3. The rotor of claim 1, wherein the plurality of stacked laminations includes steel, and wherein the at least one stud member includes steel.

4. The rotor of claim 1, wherein the first thickness is between about 2 mm and about 25 mm.

5. The rotor of claim 1, wherein each of the plurality of laminations further includes an electrically insulating coating.

6. The rotor of claim 1, wherein the compression is at a pressure sufficient to provide a necessary bending stiffness to the rotor body and a necessary frictional capability to transmit a torque load from the rotor body to a drive shaft.

7. The rotor of claim 6, wherein the compression is at a pressure of between about 7,000 kPa about 50,000 kPa.

8. The rotor of claim 1, wherein the first end flange member and the second end flange member are shaped to provide nearly uniform pressure over an entirety of a cross section of the lamination stack.

9. The rotor of claim 1, further including a plurality of balancing laminations, each balancing lamination having a second thickness that is greater than the first thickness,
each balancing lamination further including a plurality of holes located on an outer circumference of the balancing lamination between the plurality of slots,
wherein the balancing laminations are located between the laminations having the first thickness in the lamination stack.

10. An electric machine comprising:
a rotor including:
a rotor body including a lamination stack, the stack including a plurality of stacked laminations, each lamination having a first thickness, each lamination further having a plurality of radially extending slots arranged about a circumference of each of the plurality of laminations;
a first end flange member located on a first end of the lamination stack,
a second end flange member located on a second end of the lamination stack,
at least one stud member passing longitudinally through at least one hole in the lamination stack, the first end flange member, and the second end flange member,
a first fastener affixed to a first end of each of the at least one stud member,
at least a second fastener affixed to a second end of each of the at least one stud member,
the first and second fasteners providing a compression to the laminated stack,
a plurality of coils positioned within the plurality of slots; and
a stator surrounding the rotor.

11. The electric machine of claim 10, further comprising:
a first spacer member located adjacent to the first end flange member;
a second spacer member located adjacent to the second end flange member;
a non-drive end shaft spindle affixed to the first spacer member; and
a drive-end shaft spindle affixed to the second spacer member,
wherein the at least one stud member passes through at least one hole in each of the first and second spacer members.

12. The electric machine of claim 10, wherein the plurality of stacked laminations includes steel, and wherein the at least one stud member includes steel.

13. The electric machine of claim 10, wherein the first thickness is between about 2 mm and about 25 mm.

14. The electric machine of claim 10, wherein each of the plurality of laminations further includes an electrically insulating coating.

15. The electric machine of claim 10, wherein the compression is at a pressure of between about 7,000 kPa about 50,000 kPa.

16. The electric machine of claim 10, wherein the first end flange member and second end flange member are shaped to provide nearly uniform pressure over an entirety of a cross section of the lamination stack.

17. The electric machine of claim 10, the rotor further including a plurality of balancing laminations, each balancing lamination having a second thickness that is greater than the first thickness,
each balancing lamination further including a plurality of holes located on an outer circumference of the balancing lamination between the plurality of slots,
wherein the balancing laminations are located between the laminations having the first thickness in the lamination stack.

18. A method comprising:
removing a first end portion of a rotor body;
affixing at least one stud member to a first end of the rotor body;
providing a plurality of laminations, each lamination having at least one hole in the lamination;
stacking the laminations on a first end of the rotor body, including passing the at least one stud member through the at least one hole in the plurality of laminations, the stacking further including forming a laminated stack having a length equal to a length of the first portion of the rotor;
placing an end flange member adjacent to the laminated stack, including passing the at least one stud member through at least one hole in the end flange member;
placing a spacer member adjacent to the end flange member, including passing the at least one stud member through at least one hole in the spacer member;
fastening the laminations, the end flange member, and the spacer member onto the at least one stud member with at least one fastener;
compressing the laminated stack, including tightening the at least one fastener.

19. The method of claim 18, wherein the affixing includes tapping at least one threaded hole in the first end of the rotor body, threading a first end of the at least one stud member, and threadably fastening the first end of the at least one stud member into the at least one hole.

20. The method of claim 18, the providing step further comprising providing a plurality of laminations having a thickness of between about 2 mm and about 25 mm.
